(19) United States
(12) Patent Application Publication
(10) Pub. No.: US 2024/0156661 A1
(43) Pub. Date: May 16, 2024

(54) Biodegradable Patient Support Device for Positioning During a Surgical Procedure and Patient Positioning Method

(71) Applicant: Xodus Medical, Inc., New Kensington, PA (US)

(72) Inventor: Craig Kaforey, Allison Park, PA (US)

(21) Appl. No.: 18/506,562

(22) Filed: Nov. 10, 2023

Related U.S. Application Data
(60) Provisional application No. 63/424,612, filed on Nov. 11, 2022.

(51) Int. Cl. A61G 13/12; A61G 13/04

(52) U.S. Cl. CPC A61G 13/126; A61G 13/04

(57) ABSTRACT

A patient support device for positioning a patient on a medical procedure table during a medical procedure includes a pad including a biodegradable viscoelastic foam material. The pad includes a substantially flat first surface configured to be in contact with the patient, an opposing substantially flat second surface configured to contact the medical procedure table for holding the patient support device in position against the medical procedure table, and a peripheral edge extending therebetween. A method for positioning a patient on a medical procedure table during a medical procedure is also provided. The method includes: positioning a patient support device on a tiltable medical procedure table, such that the second surface of the pad contacts a surface of the medical procedure table; positioning a torso of the patient on the first surface of the pad; and tilting the medical procedure table.

### CROSS REFERENCE TO RELATED APPLICATION

This application claims the benefit of U.S. Provisional Patent Application No. 63/424,612, filed Nov. 11, 2022, the disclosure of which is hereby incorporated by reference in its entirety.

### BACKGROUND

### Field of the Invention

The invention relates generally to pads, cushions, pillows, and supports for cushioning and positioning a patient's body and, specifically, to a biodegradable viscoelastic foam pad configured to support a patient during a surgical procedure.

### Description of Related Art

Patient positioning devices, such as mats, pads, mattresses, cushions, and pillows, of various designs are used for holding a patient in a desired position during a surgical procedure. For example, elongated foam pads, such as pads formed from egg-crate foam, can be placed between a patient's torso and an operating table for comfort. Also, foam pillows of various shapes can be used to hold arms, shoulders, legs, and other body parts in desired positions during a surgical procedure. In some cases, the patient positioning devices can include integral straps, cables, buckles, or ties for securing the devices in place on the operating table at desired positons. In other examples, medical tape, twist ties, or temporary adhesives can be used for tying or otherwise securing the positioning devices in place.

Many patient positioning devices, such as mats, pads, cushions, and pillows, are intended to be single-use products that are used for a single patient and/or medical procedure and then discarded. Pads and other patient positioning devices often comprise synthetic polymer materials formed from petrochemicals that do not degrade or degrade very slowly. Environmental impacts of disposable single-use products would be reduced if any discarded products were biodegradable and/or degraded quickly after use. The patient positioning devices of the present disclosure are configured to address these issues.

### SUMMARY

According to an aspect of the present disclosure, a patient support device for positioning a patient on a medical procedure table during a medical procedure includes a pad having a biodegradable viscoelastic foam material. The pad includes a substantially flat first surface configured to be in contact with the patient, an opposing substantially flat second surface configured to contact the medical procedure table for holding the patient support device in position against the medical procedure table, and a peripheral edge extending therebetween.

According to another aspect of the present disclosure, a method of positioning a patient on a medical procedure table during a medical procedure includes positioning the patient support device, as previously described, on a tiltable medical procedure table, such that the second surface of the pad contacts a surface of the medical procedure table. The method also includes positioning a torso of the patient on the first surface of the pad and tilting the medical procedure table to position the torso of the patient at an angle suitable for performing the medical procedure.

Non-limiting illustrative examples of embodiments of the present disclosure will now be described in the following numbered clauses.

Clause 1: A patient support device for positioning a patient on a medical procedure table during a medical procedure, comprising: a pad comprising a biodegradable viscoelastic foam, the pad further comprising a substantially flat first surface configured to be in contact with the patient, an opposing substantially flat second surface configured to contact the medical procedure table for holding the patient support device in position against the medical procedure table, and a peripheral edge extending therebetween.

Clause 2: The patient support device of clause 1, wherein the medical procedure is a procedure performed with the patient in a Trendelenburg or a reverse Trendelenburg position.

Clause 3: The patient support device of clause 1 or clause 2, wherein the biodegradable viscoelastic foam is configured to partially or completely degrade through chemical reactions and/or by action of living organisms (e.g., microbes) over a period of days, weeks, months, or years.

Clause 4: The patient support device of clause 3, wherein the biodegradable viscoelastic foam degrades into simple or complex carbohydrates.

Clause 5: The patient support device of clause 3 or clause 4, wherein the biodegradable viscoelastic foam degrades into water, carbon dioxide, and biomass.

Clause 6: The patient support device of any of clauses 1-5, further comprising at least one strap comprising a first portion connected to the pad and a second portion configured to be connected to the medical procedure table for securing the patient support device to the table.

Clause 7: The patient support device of clause 6, wherein the first portion of the at least one strap is connected to the pad by an adhesive and/or is sewn to the pad.

Clause 8: The patient support device of any of clauses 1-7, wherein the pad has a length sufficient to extend from at least thighs of the patient to at least shoulders of the patient to support a torso of the patient placed on the pad.

Clause 9: The patient support device of any of clauses 1-8, wherein the biodegradable viscoelastic foam material comprises a polyurethane foam (e.g., a foam made by mixing polyhydroxy polyol with toluene di-isocyanate, polyester polyols, and/or polyether).

Clause 10: The patient support device of any of clauses 1-9, wherein the viscoelastic foam material has a coefficient of friction of from about 0.2 to about 2.5.

Clause 11: The patient support device of any of clauses 1-10, wherein the viscoelastic foam material has a density of about 35 kilograms per cubic meter to about 128 kilograms per cubic meter.

Clause 12: The patient support device of any of clauses 1-11, wherein the pad comprises a first foam block comprising the first surface and a second foam block comprising the second surface.

Clause 13: The patient support device of clause 12, wherein the first foam block is connected to the second foam block by at least one of an adhesive or a mechanical fastener.

Clause 14: The patient support device of clause 12 or clause 13, wherein the first foam block and the second foam block are formed from different types of viscoelastic foam materials.

Clause 15: The patient support device of any of clauses 12-14, wherein the viscoelastic foam material of the first block is more absorbent (e.g., moisture wicking) than the viscoelastic foam material of the second block.

Clause 16: The patient support device of any of clauses 12-15, wherein the viscoelastic foam material of the first block is less dense than is the viscoelastic foam material of the second block.

Clause 17: The patient support device of any of clauses 1-16, wherein the pad has a length that is greater than its width, and wherein the pad is from about 0.5 inch to 3.0 inches thick or, preferably, about 1.5 inches thick.

Clause 18: The patient support device of any of clauses 1-17, wherein the pad is substantially rectangular having a length of about 25 inches to 80 inches and a width of about 10 inches to 40 inches.

Clause 19: A method of positioning a patient on a medical procedure table during a medical procedure, the method comprising: positioning the patient support device of any of clauses 1-18 on a tiltable medical procedure table, such that the second surface of the pad contacts a surface of the medical procedure table; positioning a torso of the patient on the first surface of the pad; and tilting the medical procedure table to position the torso of the patient at an angle suitable for performing the medical procedure.

Clause 20: The method of clause 19, wherein the medical procedure is a procedure performed with the patient in a Trendelenburg or the reverse Trendelenburg position.

### BRIEF DESCRIPTION OF THE DRAWINGS

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limit of the invention.

FIG. 1A is a top view of a patient support device, according to an aspect of the present disclosure;

FIG. 1B is a perspective view of the patient support device of FIG. 1A showing indentations created by a patient supported by the device, according to another aspect of the present disclosure;

FIG. 1C is a cross-sectional view of the patient support device of FIG. 1A;

FIG. 2A is a perspective view showing a patient resting on another example of a patient support device, according to another aspect of the present disclosure;

FIG. 2B is a side view of the patient support device and patient of FIG. 2A;

FIG. 2C is a top view of the patient support device of FIG. 2A;

FIG. 3A is a top view of another example of a patient support device, according to another aspect of the present disclosure;

FIG. 3B is a cross-sectional view of the patient support device of FIG. 3A;

FIG. 4A is a top view of another example of a patient support device, according to another aspect of the present disclosure; and

FIG. 4B is a cross-sectional view of the patient support device of FIG. 4A.

### DETAILED DESCRIPTION

As used herein, the singular form of “a”, “an”, and “the” include plural referents unless the context clearly dictates otherwise. For the purposes of this specification, unless otherwise indicated, all numbers expressing quantities of ingredients, reaction conditions, dimensions, physical characteristics, and so forth used in the specification and claims are to be understood as being modified in all instances by the term “about.”

As used herein, the terms “right”, “left”, “top”, and derivatives thereof shall relate to the invention as it is oriented in the drawing figures. However, it is to be understood that the invention can assume various alternative orientations and, accordingly, such terms are not to be considered as limiting. Also, it is to be understood that the invention can assume various alternative variations and stage sequences, except where expressly specified to the contrary. It is also to be understood that the specific devices and processes illustrated in the attached drawings, and described in the following specification, are examples. Hence, specific dimensions and other physical characteristics related to the embodiments disclosed herein are not to be considered as limiting.

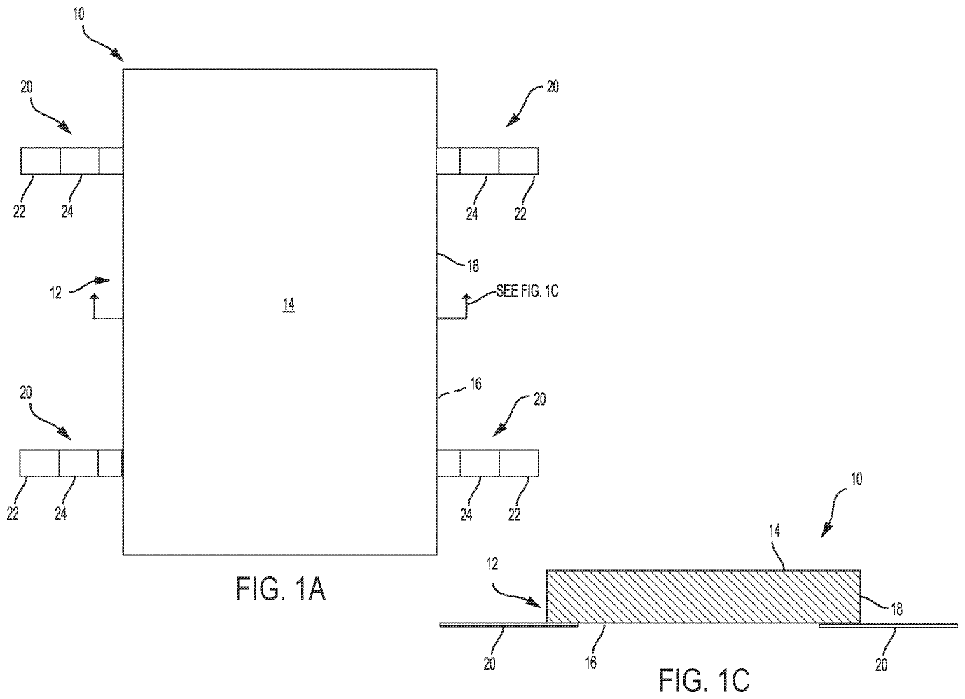

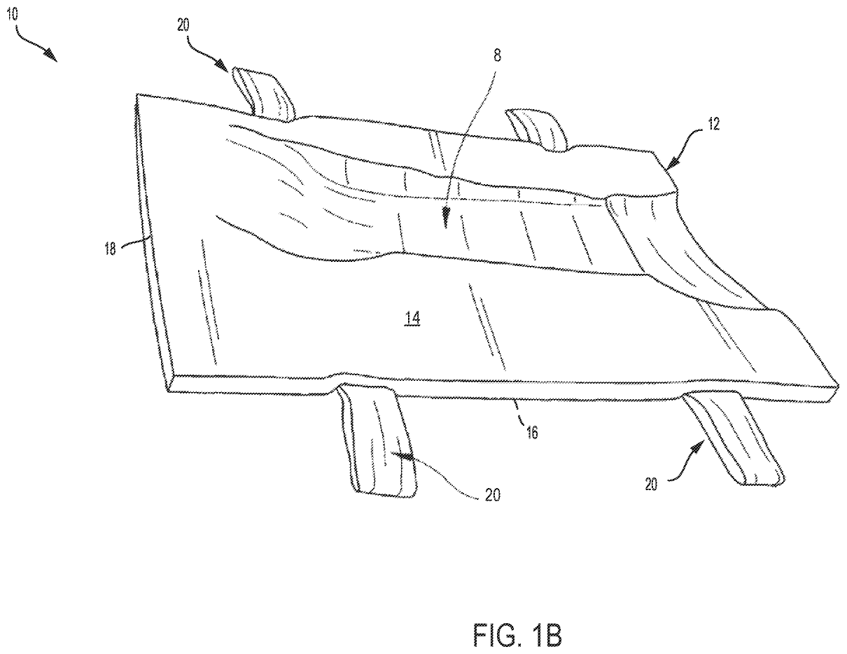

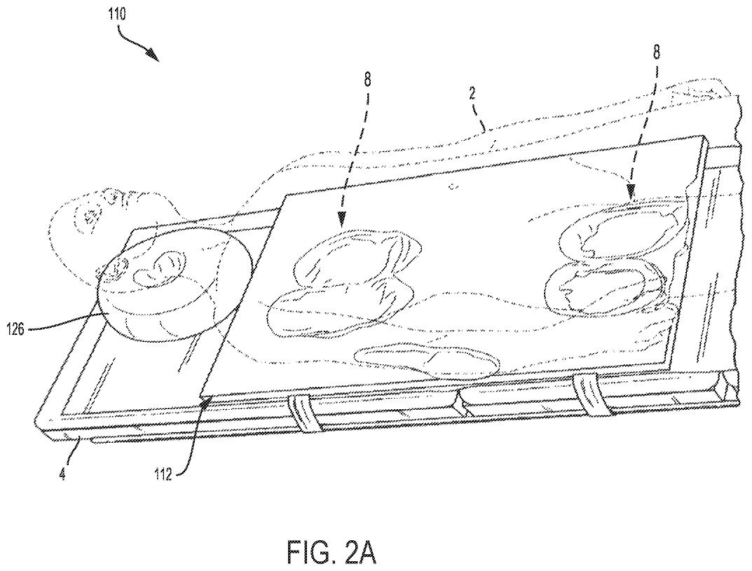

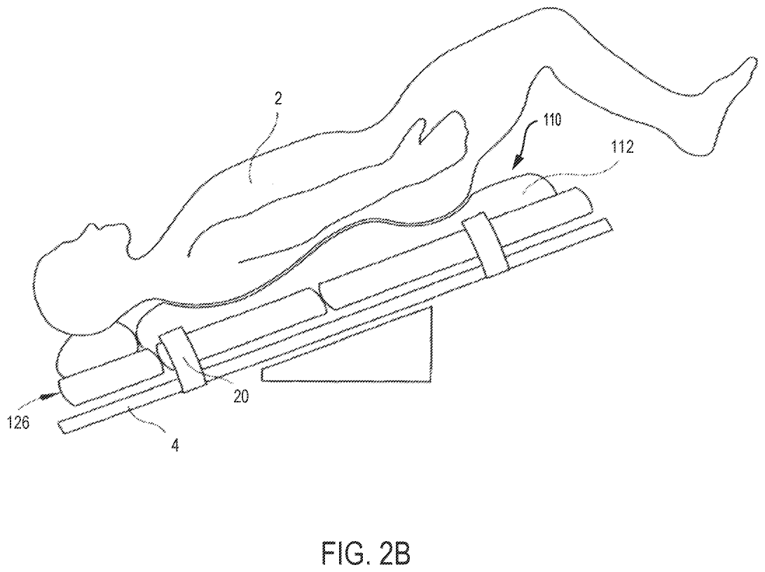

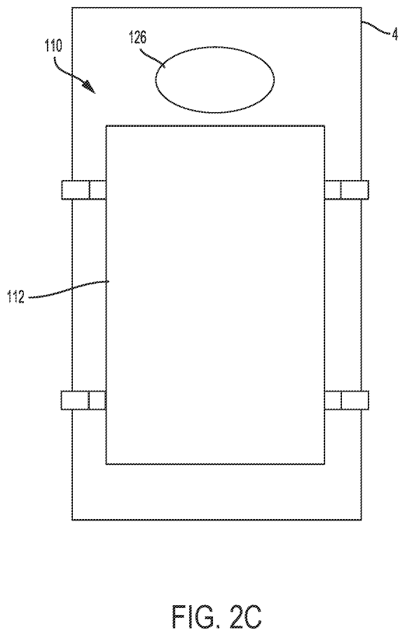

FIGS. 1A-1C show a patient support device 10 for positioning a patient 2 (shown in FIGS. 2A and 2B) on a medical procedure table 4 (shown in FIGS. 2A and 2B) during a medical (e.g., surgical) procedure. The patient support device 10 can be configured to support the patient 2 during surgical procedures including, for example, gynecological procedures, colorectal procedures, urological procedures, laparoscopic procedures, or robotic procedures. In some examples, the patient support device 10 can be used to support the patient 2 in the Trendelenburg position (as shown in FIG. 2B) or the reverse Trendelenburg position with the medical procedure table 4 positioned at an angle of from about 10 degrees to about 45 degrees, or from about 15 degrees to about 30 degrees.

The patient support device 10 comprises material(s) selected to maintain positioning of the patient 2 for a duration of the surgical procedure. In particular, the patient support device 10 is configured to prevent the patient 2 from sliding (e.g., sliding forward, backward, right, or left) relative to the patient support device 10, as well as to prevent the patient 2 from rolling off of the patient support device 10. Further, the patient support device 10 can be configured to maintain positioning of the patient 2 without using straps or other accessories to secure the patient 2 to the patient support device 10. More specifically, the patient support device 10 can be formed from deformable and resilient materials, so that depressions 8 (shown in FIGS. 1B and 2A) can be formed under the patient 2. The depressions 8 are desirably of sufficient shape and depth to limit movement of the patient 2 relative to the patient support device 10, thereby maintaining patient positioning during the surgical procedure.

In addition to maintaining positioning of the patient support device 10 relative to the patient 2, the patient support device 10 is also configured to remain in position relative to the medical procedure table 4 throughout the surgical procedure. For example, the patient support device 10 can be configured to remain flat against a surface of the medical procedure table 4, without sliding, folding over, lifting off of, or otherwise moving relative to the medical procedure table 4, and without using straps, adhesives, tape, or other accessories to hold the patient support device 10 in place. Importantly, as previously described, the patient support device 10 is configured to maintain patient positioning even when the medical procedure table 4 is moved to a steep incline, as occurs during Trendelenburg and reverse Trendelenburg positioning.

The patient support device 10 comprises a pad 12 formed from a biodegradable and/or bioerodible viscoelastic foam material. In some examples, the pad 12 comprises a substantially flat first or upper surface 14 configured to be in contact with the patient 2, an opposing substantially flat second or lower surface 16 configured to contact a surface of the medical procedure table 4, and a peripheral edge 18 extending therebetween. In some examples, the pad 12 has a length sufficient to extend from at least thighs of the patient 2 to at least shoulders of the patient 2 to support a torso of the patient 2. For example, the pad 12 can be about 25 inches to about 80 inches long, about 10 inches to about 40 inches wide, and about 0.5 inch to about 3.0 inches thick, or preferably about 1.5 inches thick. In some examples, the pad 12 can be a full length pad (e.g., about 60 inches to about 80 inches in length), which extends a full length of the medical procedure table 4 and/or is long enough to support the patient's entire body.

While not necessary to maintain patient positioning, the patient support device 10 can further comprise straps 20 for securing the patient support device 10 to the medical procedure table 4 in order to increase practitioner confidence and/or to overcome any concerns the practitioner may have about patient movement during a surgical procedure. In some examples, the straps 20 can comprise a first end portion, a second end portion, and an intermediate portion therebetween. The intermediate portion of the straps 20 can be attached to a surface of the pad 12, while the end portions of the straps 20 can be free (i.e., not attached to the pad 12). For example, the intermediate portion of the straps 20 can be connected to the pad 12 by an adhesive (e.g., glue) and/or are sewn to the pad 12. The straps 20 can be configured to be attached to portions of the medical procedure table 4 or bed, such as to rails, sides, edges, or posts of the operating table or bed, for helping to secure the patient support device 10 in a desired position on the medical procedure table 4 or bed. In some examples, the straps 20 can include a hook 22 and loop 24 fabric fastener (e.g., Velcro®) for attaching the straps 20 to the medical procedure table 4 or bed. Alternatively or in addition, the straps 20 can include ties, buckles, clips, clamps, fasteners, or other connectors known in the art, for attaching the straps 20 to portions of the medical procedure table 4 or bed.

As previously described, the pad 12 and/or other components of the patient support device 10 can be formed from the biodegradable viscoelastic foam material. Using a biodegradable material can be especially important for patient support devices 10, such as the devices disclosed herein, which are intended to be single-use products, which are discarded following a single surgical procedure. For example, the biodegradable pad 12 and/or other components of the patient support device 10 can be safely disposed of through aerobic and anaerobic solid-waste-treatment plants. In other examples, the biodegradable pad 12 and/or other components of the patient support device 10 can be discarded to a biologically active landfill, with appropriate conditions to encourage degradation of biodegradable materials. By contrast, other patient support devices, such as beds, mattresses, or reusable pads, are often formed from more durable materials, which do not degrade when exposed to liquids, fluids, or other conditions. Reusable beds, mattresses, or pads are often enclosed within a cover (e.g., a water resistant, water proof, and/or sealed cover) to prevent patient fluids from contacting and/or being absorbed by the mattress or pad. By contrast, the biodegradable or bioerodible patient support devices 10 of the present disclosure are intended for single use and, often, are not enclosed within any sort of sealed cover. Instead, the pad 12 can directly contact the patient's skin and/or the surface of the medical procedure table 4, which can contribute to the movement restricting capabilities of the pad 12.

As used herein, a “biodegradable” or “bioerodible” material of the pad 12 can be a material that degrades either partially or completely through chemical reactions and/or by action of living organisms (e.g., microbes). For example, a biodegradable viscoelastic foam material can degrade into component parts (e.g., water, carbon dioxide, simple or complex carbohydrates, and biomass). Preferably, the biodegradable material degrades over a reasonable time period of days, weeks, or months. Non-limiting examples of chemical reactions for biodegradable materials, such as biodegradable polymers, can include, for example, acid/base reactions, hydrolysis reactions, oxidation, and enzymatic cleavage. The biodegradation rate of the viscoelastic foam material can be adjusted so that the material degrades over a useful time period.

In some examples, the biodegradable viscoelastic foam material disclosed herein can be a material that is fully biodegradable as defined by the ASTM D5511-18 standard, which describe anaerobic biodegradation of plastic materials under high-solids anaerobic-digestion conditions. For example, the pad 12 can be configured to degrade by at least 70% within 30 days under testing conditions specified by ASTM D5511-18. Specifically, the percentage of biodegradability can be obtained by determining a percent of conversion of carbon from the test material (e.g., the pad 12) to carbon in a gaseous phase (CH₄ and CO₂). The percentage of biodegradability does not include an amount of carbon from the test material (e.g., the pad 12) that is converted to cell biomass and that is not, in turn, metabolized to CO₂ and CH₄. In other examples, the pad 12 can be configured to degrade by at least 80%, 90%, or 95% within 30 days under the ASTM D5511-18 testing conditions. In other examples, the pad 12 can be configured to degrade by at least 70%, within 10 days under the ASTM D5511-18 testing conditions.

It is also important that the foam pad 12 comprises a viscoelastic material in order to maintain positioning relative to the patient 2 and medical procedure table 4. More specifically, the foam pad 12 of the patient support device 10 can comprise a high viscosity foam material (often referred to as a “memory foam” material) which limits patient movement or sliding. In some examples, the viscoelastic foam material of the pad 12 can be a polyurethane foam (e.g., a foam made by mixing polyhydroxy polyol with toluene di-isocyanate, polyester polyols, and/or polyether polyols).

In some examples, the surfaces 14, 16 of the foam pad 12 may have a high coefficient of static friction, stickiness, or tackiness. As a result of such surface properties, the patient 2 may, in effect, stick to the patient support device 10, thereby limiting patient movement and preventing the pad 12 from sliding from the medical procedure table 4 even when the straps 20 are not attached to portions of the medical procedure table 4.

In some examples, the viscoelastic foam material comprises a viscoelastic polyurethane foam material with a glass transition temperature that is substantially less than a glass transition temperature for a conventional (non-viscoelastic foam). For example, the viscoelastic polyurethane foam can have a glass transition temperature of about or exceeding 0° C. or, for example, between about −10° C. and about 10° C. or between about −5° C. and about 5° C. By contrast, glass transition temperature for a conventional (non-viscoelastic foam) is about −50° C.

In some examples, the viscoelastic foam material of the pad 12 can have one or more of the following mechanical properties: a ball rebound (ASTM D-3574) of less than 40%, or less than about 20%, or about 0.1% to about 20%, or about 1% to about 10%; a density (ASTM D-3574) of about 1 pcf to about 10 pcf, or about 2 pcf to about 8 pcf, or about 5 pcf to about 6.5 pcf (about 15 kilograms per cubic meter to about 150 kilograms per cubic meter, or about 35 kilograms per cubic meter to about 128 kilograms per cubic meter, or about 83 kilograms per cubic meter to about 103 kilograms per cubic meter); and/or an indentation force deflection (ASTM D-3574) of about 5 lbf (2.25 kg) to about 20 lbf (9 kg), or about 7 lbf (3.1 kg) to about 15 lbf (6.8 kg). The viscoelastic foam material of the pad 12 can also have one or more of the following mechanical properties: a compression set (22 hrs. @ 70° C.), for a 25 percent compression, of less than 0.5 percent (ASTM D-3574); an air flow in the range of 0.3 to 1.0 cubic foot per minute (ASTM D-3574); a tensile strength of about 8 pounds per square inch to about 12 pounds per square inch; and/or a coefficient of static friction of about 0.2 to about 2.5. Examples of viscoelastic foam materials, which can be used with the patient support device 10 of the present disclosure, are described, for example, in: U.S. Pat. Nos. 8,464,720; 9,161,876; 9,782,287; and 11,266,525, which are incorporated herein by reference in their entireties.

As previously described, in some examples, the viscoelastic foam can be configured to prevent the patient 2 from sliding off of the pad 12, even when the medical procedure table 4 and patient support device 10 are at an angle (e.g., when the patient 2 is an the Trendelenburg or reverse Trendelenburg position). In a similar manner, the viscoelastic foam material can also be selected so that the lower surface 16 of the pad 12 frictionally engages and/or remains in place against the medical procedure table 4, such that the patient support device 10 does not slide relative to the medical procedure table 4, even when the medical procedure table 4 is moved by a substantial amount (e.g., moved to an angle of about 10 degrees to about 45 degrees).

In use, during a surgical procedure, the patient support device 10 is placed on a medical procedure table 4 (e.g., an operating table). The patient 2 and, in some cases, a cover or lift sheet are lowered onto the medical procedure table 4, so that the patient support device 10 is situated between the patient and the medical procedure table 4. The upper surface 14 of the pad 12 may or may not contact the skin of the patient 2. In some examples, the pad 12 of the patient support device 10 can be configured to at least partially conform to the patient's body shape and, in particular, to form depressions under the patient's body weight for maintaining the patient's body position on the foam pad 12 of the patient support device 10. In addition, the pad 12 can be configured to provide comfort and to prevent injuries, such as pressure sores, tissue damage, skin breakdown, and muscle damage, which may occur when the patient's skin contacts hard, rigid surfaces for extended periods of time.

FIGS. 2A and 2B show another example of a patient support device 110. As in previous examples, the patient support device 110 includes a rectangular pad 112 comprising the biodegradable viscoelastic foam material. As previously described, the biodegradable viscoelastic foam material is selected to maintain patient positioning throughout a surgical procedure. The patient support device 110 of FIGS. 2A and 2B further comprises a head support 126. The head support 126 can be a pillow, cushion, pad, or similar structure formed from or comprising a biodegradable material. For example, the head support 126 can be formed from the same viscoelastic biodegradable material as the pad 112. In other examples, the head support 126 can be formed from another biodegradable material, such as another type of viscoelastic or non-viscoelastic biodegradable foam.

In some examples, the head support 126 can be a head mask structure configured to protect a patient's head during, for example, robotic surgical procedures. A head mask structure can include a foam body (e.g., a body formed from a biodegradable viscoelastic or non-viscoelastic foam) including a hollowed out portion configured to receive the patient's head. The head mask structure can also include one or more head covering structures for contacting and maintaining positioning of the patient's head during, for example, a robotic surgical procedure. An exemplary head mask structure, which can be modified to include the biodegradable viscoelastic or non-viscoelastic foam disclosed herein, and which can be used with the patient support device 110, is disclosed in U.S. Pat. No. 10,842,574, entitled “Robotic patient protection system comprising a head mask structure, configured to protect the head of a patient, for use in robotic surgical procedures,” which is incorporated by reference in its entirety.

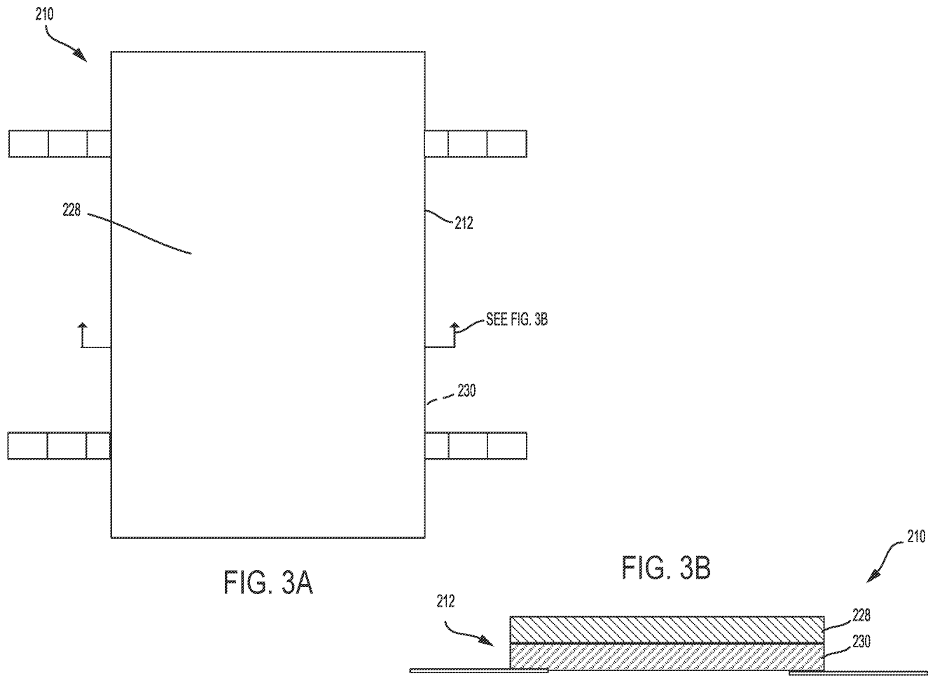

FIGS. 3A and 3B show another example of a patient support device 210 including features of the present disclosure. As shown in FIGS. 3A and 3B, the patient support device 210 comprises a pad 212 comprising a first or upper block 228 and a second or lower block 230. In some examples, the blocks 228, 230 can be formed from a same type of viscoelastic foam material (e.g., from a viscoelastic foam material having the same density, porosity, coefficient of friction, glass transition temperature, chemical composition, or other features). In other examples, the upper block 228 and the lower block 230 can be formed from different viscoelastic foam materials, such as materials having a different porosity, absorbance, glass transition temperature, or density. For example, the viscoelastic foam material of the upper block 228 can be more absorbent (e.g., moisture wicking) than the viscoelastic foam material of the lower block 230 in order to quickly absorb any liquids that collect on an outer surface of the foam pad 212 and/or on other portions of the patient support device 210.

In some examples, the material of the upper block 228 can also be less dense than the material of the lower block 230 to provide good patient comfort. In particular, the upper block 228 can be formed from a less dense (e.g., soft or plush) material that deforms under a weight of the patient creating a depression for receiving a portion of the patient's torso. By contrast, the lower block 230 can be formed from a more dense material that substantially maintains its shape when the patient's weight is exerted against the patient support device 210. As such, the lower block 230 may not deform in order to maintain good contact with the surface of the medical procedure table to hold the patient support device 210 in place against the table. In some examples, the upper block 228 can be formed from an open-cell viscoelastic foam, which is absorbent and easily deformable. By contrast, the lower block 230 can be formed from a closed cell foam that is non-absorbent and/or which does not substantially deform under weight of the patient.

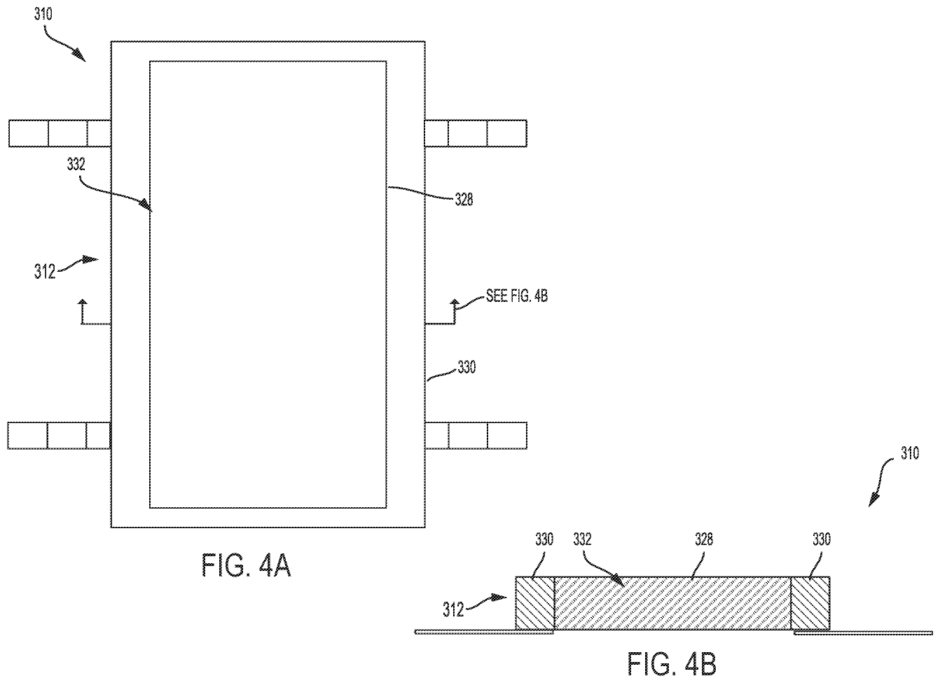

FIGS. 4A and 4B show another example of a patient support device 310 comprising biodegradable viscoelastic foam. As in previous examples, the patient support device 310 comprises a pad 312. The pad 312 is formed from separate foam blocks, namely an inner block 328, which can be square or rectangular in shape, and an outer block 330, which comprise an opening or cavity 332 sized to receive the inner block 328. The inner block 328 can be inserted into the cavity 332 of the outer block 330 during manufacture and adhered in place using a biodegradable adhesive or biodegradable fasteners.

As with the patient support device 210 of FIGS. 3A and 3B, the blocks 328, 330 of the patient support device 310 can be formed from a same type of biodegradable viscoelastic foam material (e.g., from a viscoelastic foam material having the same density, porosity, coefficient of friction, chemical composition, glass transition temperature, or other features). In other examples, the inner block 328 and the outer block 330 can be formed from different biodegradable foam materials, such as materials having a different porosity, absorbance, glass transition temperature, or density. For example, the viscoelastic foam material of the inner block 328 can be more absorbent (e.g., moisture wicking) than the viscoelastic foam material of the outer block 330 in order to quickly absorb any liquids that collect on an outer surface of the foam pad 312 and/or on other portions of the patient support device 310. The material of the inner block 328 can also be less dense than the material of the outer block 330 to provide good patient comfort. In particular, the inner block 328 can be formed from a less dense (e.g., soft or plush) material that deforms under a weight of the patient creating a depression for receiving a portion of the patient's torso. By contrast, the outer block 330 can be formed from a more dense material that substantially maintains its shape when the patient's weight is exerted against the patient support device 310. As such, the outer block 330 may not deform in order to maintain good contact with the surface of the medical procedure table to hold the patient support device 310 in place against the table. In some examples, the inner block 328 can be formed from an open-cell viscoelastic foam, which is absorbent and easily deformable. By contrast, the outer block 330 can be formed from a closed cell foam that is non-absorbent and/or which does not substantially deform under weight of the patient. In some examples, the outer block 330 could also be formed from a non-viscoelastic biodegradable foam, as the outer block 330 is unlikely to contact the patient's skin and/or depressions for maintaining positioning of the patient are unlikely to be formed in the outer block 330.

While examples of the patient support devices 10, 110, 210, 310 and methods of use of the present disclosure are shown in the accompanying figures and described hereinabove in detail, other examples will be apparent to, and readily made by, those skilled in the art without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. A patient support device for positioning a patient on a medical procedure table during a medical procedure, comprising:
a pad comprising a biodegradable viscoelastic foam, the pad further comprising a substantially flat first surface configured to be in contact with the patient, an opposing substantially flat second surface configured to contact the medical procedure table for holding the patient support device in position against the medical procedure table, and a peripheral edge extending therebetween.

2. The patient support device of claim 1, wherein the medical procedure is a procedure performed with the patient in a Trendelenburg or a reverse Trendelenburg position.

3. The patient support device of claim 1, wherein the biodegradable viscoelastic foam is configured to partially or completely degrade through chemical reactions and/or by action of living organisms (e.g., microbes) over a period of days, weeks, months, or years.

4. The patient support device of claim 3, wherein the biodegradable viscoelastic foam degrades into simple or complex carbohydrates.

5. The patient support device of claim 3, wherein the biodegradable viscoelastic foam degrades into water, carbon dioxide, and biomass.

6. The patient support device of claim 1, further comprising at least one strap comprising a first portion connected to the pad and a second portion configured to be connected to the medical procedure table for securing the patient support device to the table.

7. The patient support device of claim 6, wherein the first portion of the at least one strap is connected to the pad by an adhesive and/or is sewn to the pad.

8. The patient support device of claim 1, wherein the pad has a length sufficient to extend from at least thighs of the patient to at least shoulders of the patient to support a torso of the patient placed on the pad.

9. The patient support device of claim 1, wherein the biodegradable viscoelastic foam material comprises a polyurethane foam (e.g., a foam made by mixing polyhydroxy polyol with toluene di-isocyanate, polyester polyols, and/or polyether).

10. The patient support device of claim 1, wherein the biodegradable viscoelastic foam material has a coefficient of friction of from about 0.2 to about 2.5.

11. The patient support device of claim 1, wherein the biodegradable viscoelastic foam material has a density of about 35 kilograms per cubic meter to about 128 kilograms per cubic meter.

12. The patient support device of claim 1, wherein the pad comprises a first foam block comprising the first surface and a second foam block comprising the second surface.

13. The patient support device of claim 12, wherein the first foam block is connected to the second foam block by at least one of an adhesive or a mechanical fastener.

14. The patient support device of claim 12, wherein the first foam block and the second foam block are formed from different types of viscoelastic foam materials.

15. The patient support device of claim 12, wherein the viscoelastic foam material of the first block is more absorbent than the viscoelastic foam material of the second block.

16. The patient support device of claim 12, wherein the viscoelastic foam material of the first block is less dense than is the viscoelastic foam material of the second block.

17. The patient support device of claim 1, wherein the pad has a length that is greater than its width, and wherein the pad is from about 0.5 inch to about 3.0 inches thick or, preferably, about 1.5 inches thick.

18. The patient support device of claim 1, wherein the pad is substantially rectangular having a length of about 25 inches to about 80 inches and a width of about 10 inches to about 40 inches.

19. A method of positioning a patient on a medical procedure table during a medical procedure, the method comprising:
positioning the patient support device of claim 1 on a tiltable medical procedure table, such that the second surface of the pad contacts a surface of the medical procedure table;
positioning a torso of the patient on the first surface of the pad; and
tilting the medical procedure table to position the torso of the patient at an angle suitable for performing the medical procedure.

20. The method of claim 19, wherein the medical procedure is a procedure performed with the patient in a Trendelenburg or the reverse Trendelenburg position.
